(19) United States
(12) Patent Application Publication
(10) Pub. No.: US 2025/0170578 A1
(43) Pub. Date: May 29, 2025

(54) IMPACT CRUSHER ASSEMBLY

(71) Applicant: Portafill International Limited, Dungannon (GB)

(72) Inventor: Malachy James RAFFERTY, Omagh (GB)

(73) Assignee: Portafill International Limited, Dungannon (GB)

(21) Appl. No.: 18/956,521

(22) Filed: Nov. 22, 2024

(30) Foreign Application Priority Data
Nov. 29, 2023 (GB) 2318235.5

(51) Int. Cl. B02C 13/09; B02C 23/08

(52) U.S. Cl. CPC B02C 13/095; B02C 23/08

(57) ABSTRACT

There is described an impact crusher assembly comprising a plurality of blow bars mounted on a rotor core able to rotate about an axis, a feeder for material to the blow bars, a primary impact plate co-operating with the blow bars and located radially outwardly from the blow bars, and a secondary impact plate located below the primary impact plate, wherein the secondary impact plate is translationally moveable relative to rotor core.

The invention provides an assembly able to vary the gap between the secondary impact plate and the blow bars, to allow the user to quickly and easily change the size of material crushed by the impact crusher assembly, or compensate for wear and tear.

### CROSS REFERENCE TO RELATED APPLICATIONS

This application claims priority benefit from Great Britain Application No. 2318235.5 filed on Nov. 29, 2023, entitled “Impact Crusher Assembly”, which is incorporated herein by reference in its entirety.

### FIELD OF THE INVENTION

The present invention relates to an impact crusher assembly able to reduce various materials to smaller materials, particularly but not exclusively into materials for subsequent use, and a method of using an impact crusher assembly.

### BACKGROUND TO THE INVENTION

Impact crushers are able to reduce various materials such as concrete, asphalt, rock, rubble and stone, into smaller sized materials. The smaller sized materials may be reusable, and therefore a valuable commodity product in their own right.

An impact crusher generally handles a feed material provided by or along a feeder or feed hopper or feed conveyor into a crushing zone, being an area having a rotor with hammers or blow bars. The feed material is rotated by the blow bars against a main impact wall or plate, sometimes also called an apron, having a series of thick or armoured wear plates. The material is thrown against the main impact wall or plate and starts to ricochet between the blow bars and the wall and other material particles, until it is reduced in size to pass out of the crushing zone, and towards a suitable collection place, generally at the bottom of the crushing zone. Typically, the collection place is or has one end of an outlet conveyor, able to convey the outlet material in its reduced size to a suitable store, location or to waiting transportation.

To help protect the outlet conveyor, an impact crusher can have a secondary impact plate located below the main impact plate. Thus, the outlet for the crushed material is the gap between the blow bars and the bottom of the secondary impact plate.

Impact crushers can sometimes be fed with ‘uncrushable’ material or objects, typically termed ‘tramp material’. If tramp material is larger than the gap between the blow bars and the secondary impact plate, the secondary impact plate can be hinged to allow the bottom of the secondary impact plate to rotatably fold away or back from the rotor and blow bars, to temporarily increase the outlet gap, and so to allow tramp material to still escape from the crushing zone.

The present invention relates to an improvement to an impact crusher.

### SUMMARY OF THE INVENTION

According to one aspect of the present invention, there is provided an impact crusher assembly comprising a plurality of blow bars mounted on a rotor core able to rotate about an axis, a feeder for material to the blow bars, a primary impact plate co-operating with the blow bars and located radially outwardly from the blow bars, and a secondary impact plate located below the primary impact plate, wherein the secondary impact plate is translationally moveable relative to rotor core.

Optionally, the secondary impact plate comprises one or more impact facing bars mounted on an impact support frame or secondary support frame, and the secondary support frame is translationally moveable relative to the rotor core. Typically, the primary impact plate is mounted on a primary support frame or mechanism.

Optionally, the secondary impact frame comprises a sliding mechanism able to change the gap between the secondary impact plate and the rotor core.

Optionally, the sliding mechanism comprises a fixed part, and a relatively moveable part attached to the secondary impact plate.

Optionally, the fixed part comprises side bars, and the relatively moveable part comprises complementary slide rails.

Optionally, the gap between the secondary impact plate and the rotor core is adjustable hydraulically or manually or both.

Optionally, the impact support frame or secondary support frame further includes a tramp metal relief mechanism. A tramp metal relief mechanism may have one or more support configurations, such as moving with the support frame, or being fixed to the moving frame at one end and attached to a crushing chamber at the other end, or being attached to a primary support frame, each allowing readjustment or reconfiguration for different positions.

A tramp metal relief mechanism can comprise one or more of a mechanical spring, hydraulic shock absorber, and pneumatic shock absorber, to allow for rotational movement of the secondary impact plate relative to rotor core.

A tramp metal relief mechanism can set at angle of the secondary impact plate relative to the rotor core using a suitable adjustment means or mechanism, such as by threaded rods, pins, bolts and packing shims, or any combination thereof.

The linear position of the secondary impact plate relative to rotor core can be set manually and/or hydraulically, and can be secured by using one or more of a hydraulic ram, bolts, threaded rods, locking pins, shims, wedges, or a combination of any of any one of these components.

The current design implements a hydraulic cylinder and threaded rods. Optionally, the present invention further includes an outlet conveyor below the rotor core, and wherein the secondary impact plate is located between the primary impact plate and the outlet conveyor.

Optionally, the secondary support frame also includes a secondary impact plate hinge and relief mechanism.

Optionally, the present invention further comprises an adjustable movement control mechanism

Optionally, the present invention further comprises a pre-screener between the feeder and the rotor core.

Optionally, the pre-screener comprises a fixed grid and a moveable grid.

Optionally, the moveable grid is moveable in an eccentric motion relative to the fixed grid.

Optionally, the present invention is mounted on a mobile chassis.

Optionally, the feeder is a top gravity feeder.

According to a second aspect of the present invention, there is provided a method of impact crushing material in an impact crusher assembly as defined herein, comprising the steps of:
(a) providing material to the feeder;
(b) crushing the material between the blow bars and the primary impact plate; and
(c) adjusting the gap between the secondary impact plate and rotor core by translationally moving the secondary impact plate.

Optionally, the gap between the secondary impact plate and rotor core can also be adjusted rotationally the secondary impact plate. As such, the present invention provides an impact crusher assembly and a method wherein the secondary impact plate is both translationally and rotationally moveable relative to rotor core.

Optionally, where the secondary impact plate comprises one or more impact facing bars mounted on an impact support frame, step (c) further comprises translationally moving the impact support frame relative to the rotor core.

Optionally, step (c) further comprises translationally moving the impact support frame along a sliding mechanism to change the gap between the secondary impact plate and the rotor core.

Optionally, step (c) further comprises hydraulically or manually or both translationally moving the secondary impact plate relative to the rotor core.

Optionally, the present invention further comprises adjusting the gap between the secondary impact plate and rotor core by rotationally moving the secondary impact plate.

Optionally, the impact support frame or secondary support frame further includes a tramp metal relief mechanism, and rotational movement of the secondary impact plate relative to the rotor core provides the tramp metal relief operation.

### BRIEF DESCRIPTION OF THE DRAWINGS

Embodiments of the present invention will now be described by way of example only and with reference to the accompanying drawings, in which:

FIG. 1 is a part-open view of an impact crusher assembly according to an embodiment of the present invention in a mobile impact crusher;

FIG. 2 is a part-open view of a prior art internal crushing system, in accordance with an aspect of the present disclosure;

FIG. 3a is a part-open side view of the impact crusher assembly portion of FIG. 1 in a first position, in accordance with an aspect of the present disclosure;

FIG. 3b is a part-open side view of the impact crusher assembly of FIG. 3 in a second position, in accordance with an aspect of the present disclosure;

FIG. 4a is a rear perspective and enlarged view of portion A of FIG. 3 in a first position, in accordance with an aspect of the present disclosure;

FIG. 4b is a rear perspective and enlarged view of portion A of FIG. 3 in a second position, in accordance with an aspect of the present disclosure; and

FIG. 5 is a simplified side view of the secondary impact plate, impact support frame and sliding mechanism of FIGS. 4a and 4b, with a schematic rotor core, in accordance with an aspect of the present disclosure.

### DETAILED DESCRIPTION FOR CARRYING OUT THE INVENTION

The present invention relates to an impact crusher assembly able to reduce various materials such as concrete, asphalt, rock, rubble and stone, into smaller sized materials. The smaller sized materials may be reusable, and therefore a valuable commodity product in their own right.

Impact crushers or impact crusher plants can be used in quarrying, recycling and demolition applications. Impact crushers use impact and striking as a way to reduce the size of the material in their main processing stage. The impact crusher assembly is able to utilise the high speed impact energy of the rotor core to breakdown the material into suitable or workable particle sizes.

The impact crusher assembly of the present invention has a rotor core and a plurality of blow bars mounted thereon in a manner known in the art. Typically, the number of blow bars is 2, 3, 4 or more, typically 4, and symmetrically arranged around the rotor core to extend radially therefrom. The blow bars are typically formed of a hard or hardwearing material, typically cast manganese steel which can be replaced over time. The blow bars are designed to with stand many impacts on material at the high rotation speeds of the rotor core.

The feeder for the material into the crushing area or zone of the impact crusher assembly may comprise one or more of the group comprising a hopper, a feed conveyor, a slide or a chute. Typically, the feeder has an open top and slide plates, typically inclined slide plates, to create a pathway for feed material onto a conveyor belt, which conveyor belt can provide the feed material from a feed area or end towards the rotor core and blow bars.

The area around the rotor core and blow bars can be defined as a ‘crushing zone’ or ‘crushing box’ or similar.

Optionally, the impact crusher assembly of the present invention comprises a pre-screener between the feeder and the crushing zone. The pre-screener is able to screen some of the feed material through one or more suitable sized screens, meshes, grids or similar, each typically having a pre-determined aperture size, to pre-remove material not desired or required to be crushed by the subsequent crushing action of the rotor core, etc. Typical material removed by a pre-screener can be dirt, or loose material, or ‘fines’. Such material can pass by gravity, and/or by positive action of the pre-screener, towards a suitable collection location of area, such as a suitable collection tray, or an inlet end of a suitable conveyor able to convey such material away from the impact crusher assembly.

In one embodiment of the present invention, the pre-screener comprises a fixed grid and a moveable grid. The moveable grid is moveable relative to the fixed grid. Such movement may be oscillation.

According to one embodiment of the present invention, the moveable grid is moveable in an eccentric motion relative to the fixed grid. The eccentric motion is typically in two dimensions, and may be provided by a suitable eccentric motor able to provide at least one eccentric motion, such as eccentric rotations, to cause one or more parts of the moveable grid to move in an eccentric motion relative to the fixed grid.

In one embodiment of the present invention, the moveable grid comprises a series of grid fingers, and the eccentric motion is able to move at least one end of the eccentric fingers in a linear type back and forth motion relative to the fixed grid.

Optionally, the secondary impact plate comprises one or more impact bars mounted on an impact support frame, and the impact support frame is adjustable relative to the rotor core and the axis of rotation of the blow bars. Typically, the primary impact plate is mounted on a primary support frame or mechanism.

Optionally, the secondary support frame has means able to allow the gap between the secondary impact plate and the sweep or ends of the blow bars to be translationally adjustable, such that at least the impact-portion of the secondary impact plate is wholly or substantially adjustable in this way.

In one embodiment, the secondary support frame includes a sliding mechanism able to change the gap between the secondary impact plate and the rotor core. The sliding mechanism may comprise one or more fixed parts and one or more relatively moveable parts, optionally able to relocate an impact support frame supporting the impact facing parts of the secondary impact plate.

The adjustment of the gap between the secondary impact plate and the blow bars and rotor core may be provided hydraulically, manually or both.

In one embodiment, the secondary support frame includes an actuator or other hydraulic mechanism, able to move or adjust the position of a part or portion of the secondary impact plate, and a fixed part of the secondary support frame relative to each other.

In another embodiment to the present invention, the secondary support frame includes a manual mechanism, able to move or adjust the position of a part or portion of the secondary impact plate, and a fixed part of the secondary support frame relative to each other. The manual mechanism may comprise complementary rods and nuts to help define the extent of movement of the secondary impact plate, and which is optionally adjustable manually to change the relative positions of parts of the secondary support frame.

Optionally, the secondary support frame includes a hinge and relief mechanism. Typically, the hinge and relief mechanism comprises a compression means such as a compression spring, between an impact-facing part of the secondary impact plate, and a supporting part or frame, to allow rotational hinged movement of a lower end or portion of the secondary impact plate relative to the blow bars, to allow for the exceptional passage of uncrushable or tramp material, in a manner known in the art.

Optionally, the present invention further comprises a movement control mechanism, able to define the translational extent of the movement of the secondary impact plate. Optionally, the movement control mechanism is adjustable, and has at least a maximum and minimum ends or stops able to define or regulate or control the position of the secondary impact plate relative to the rotor core. The movement control mechanism may comprise complementary rods and nuts as discussed hereinabove.

Optionally, the impact crusher assembly of the present invention is mounted on a mobile chassis. The mobile chassis may have suitable mobility based on wheels or caterpillar tracks so as to allow relocation of the impact crusher assembly to one or more sites in use.

The present invention also provides a method of impact crushing material in an impact crusher assembly as defined herein, comprising the steps of:
(a) providing material to the feeder;
(b) crushing the material between the blow bars and the primary impact plate; and
(c) adjusting the gap between the secondary impact plate and rotor core by translationally moving the secondary impact plate.

Providing material to the feeder can be provided by any suitable provider, including conveyors and loaders. The feeder provides material to the crushing zone for crushing the material between the blow bars and the primary impact plate, or at least the primary impact plate, in a manner known in the art.

Typically, such crushing is caused by the impact of the material against the primary impact plate, possibly one or more times, as the material is constantly in motion caused by rotation of the rotor core and the blow bars, often involving ricocheting between the blow bars, the impact plate and other material.

Once crushed material is small enough to fit between the blow bars and the lowest crushing part or area of the crushing zone, such material can pass towards a suitable collection point, typically at or near the bottom of the crushing zone, and typically at or near the bottom of the impact crusher assembly.

In the present invention, the method includes the step of adjusting the gap between the secondary impact plate and the rotor core in the form of the ends of the blow bars.

Adjusting the gap between the secondary impact plate and the blow bars allows the user to quickly and easily change the size of material crushed by the impact crusher assembly, and thus change the size of output feed or output feed material so as to be optimised for its subsequent storage, or location, or use. In this way, the present invention provides variation in its output to that desired or necessary by the user.

Additionally and/or alternatively, adjusting the gap between the secondary impact plate and the blow bars allows the user to compensate for ‘wear and tear’ of the secondary impact plate relative to the rotor core over time. Such wear and tear increases the gap thereinbetween, and thus changes the grade of crushed material. In particular, there is commonly wear and tear of the closest part(s) or edge(s) of the front-facing portion(s) of the secondary impact plate, generally being the front edges of its impact bars, due to the constant impact of crushed material thereagainst. Over time, such edges can become ‘worn away’, but the impact bars are still useable, so that quick and easy re-positioning of the location of the secondary impact plate relative to the rotor core, and in particular relative to the arcuate sweep of the blow bars, allows the impact crusher assembly to continue to provide the same grade or size of crushed material based on the expected gap between the front of the secondary impact plate and the rotor care.

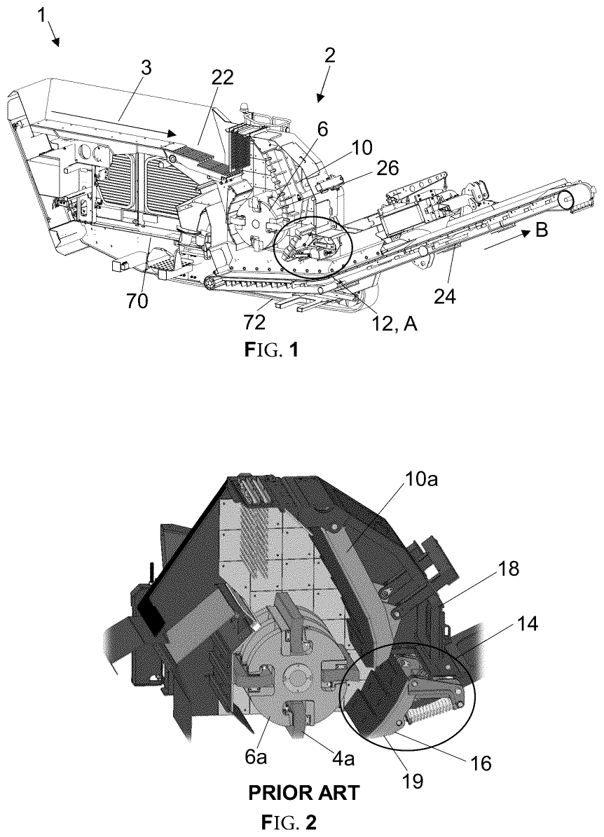

Referring to the drawings, FIG. 1 shows an impact crusher assembly 2 as the core or central part of an impact crusher 1. FIG. 1 also shows the impact crusher 1 comprising a hopper or feeder 8, a downstream pre-screen or screening unit 22 from the feeder 8, a crushing zone 26, and an in-line outlet conveyor 24. Other outlets and outlet conveyors may exist. FIG. 1 shows the direction of one line of crushed material along arrow B away from the impact crusher assembly 2 using the outlet conveyor 24 in a manner expected in the art. FIG. 1 also shows the impact crusher assembly 2 mounted on a mobile chassis 70. The mobile chassis 70 has caterpillar tracks 72 for easy relocation of the impact crusher 1 to other sites in use.

FIG. 1 also shows the impact crusher 1 having an impact crusher assembly 2 comprising a rotor core 6 and a primary impact plate 10 which help define the crushing zone 26, and a secondary impact plate 12 in the area A below the primary impact plate 10.

FIG. 2 shows a prior art arrangement for impact crushing, comprising a rotor 6a, having blow bars 4a, a primary impact plate 10a, and a fixed second plate 14. The second plate 14 is fixed in that its supporting frame 16 is not moveable relative to the remainder of the impact crushing housing 18, other than a hinged lower portion 19 in a manner known in the art.

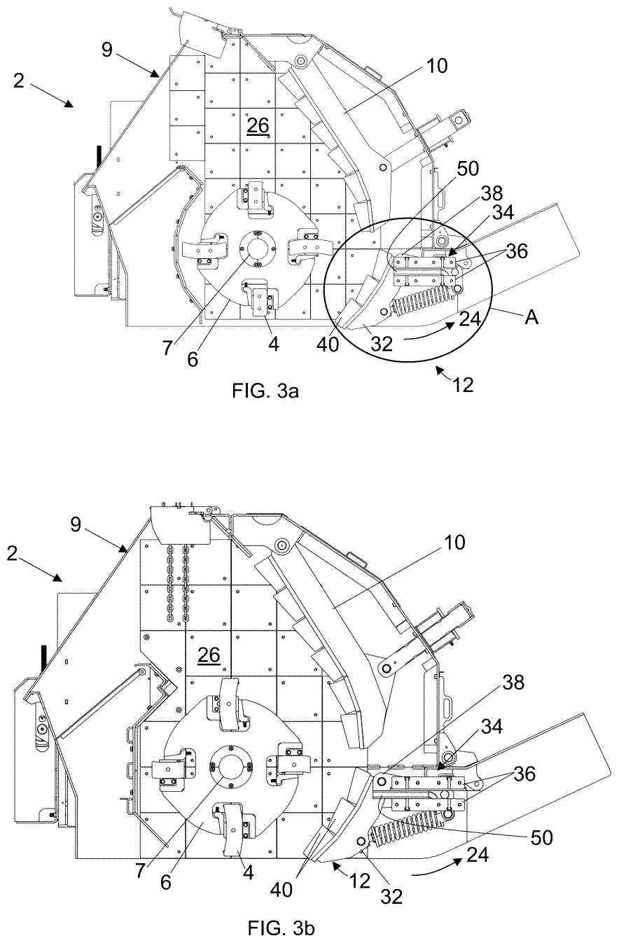

FIGS. 3a and 3b show cross-sectional views of the impact crusher assembly 2 of FIG. 1 in more detail. FIGS. 3a and 3b show the impact crusher assembly 2 comprising a plurality of (four) blow bars 4 mounted on a rotor core 6, and able to rotate about an axis 7, a feeder or feed entry 9 for material to the blow bars 4, a primary impact plate 10 co-operating with the blow bars 4 and located radially outwardly from the blow bars 4, and a secondary impact plate 12 located below the primary impact plate 10, wherein the secondary impact plate 12 is translationally moveable relative to rotor core 6.

FIGS. 3a and 3b show the secondary impact plate 12 having (for example) three impact facing bars 40 mounted on an impact support frame 32, and a sliding mechanism 34 able to change the gap between the impact bars 40, and the rotor core 6 and blow bars 4.

The sliding mechanism 34 comprises a moveable part comprising a relatively moveable plate support frame 38. The plate support frame 38 supports the impact support frame 32, and has side rails 50. The fixed part is only shown as two side bars 36 in FIGS. 3a to 5 for clarity purposes. The side bars 36 can be fixed to any suitable part of the remainder of the impact crusher assembly 2 or chassis of the impact crusher 1. The side bars 36 accommodate the side rails 50.

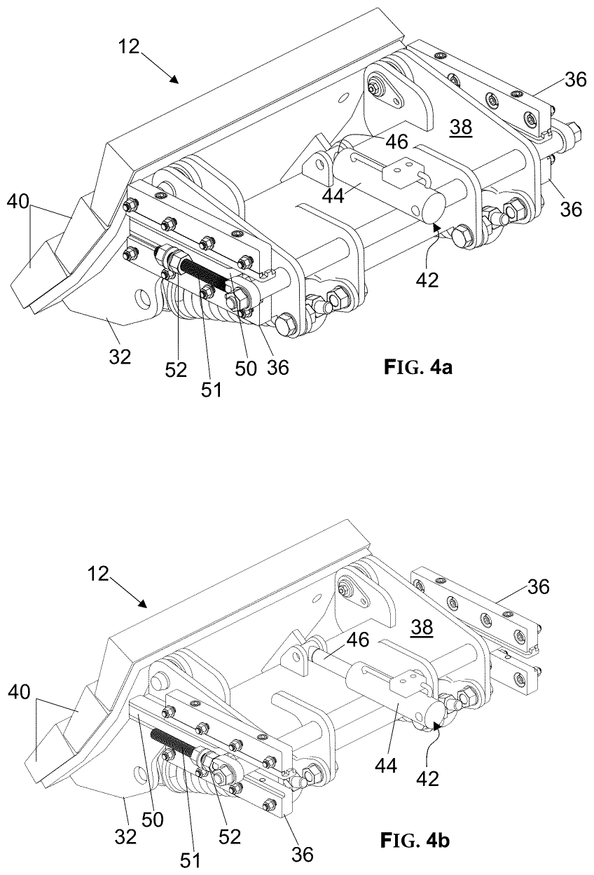

FIG. 3a shows the secondary impact plate 12 in a first position. FIG. 4a shows detail of the secondary impact plate 12 within portion A of FIGS. 1 and 3a, in the first position. FIG. 4a also shows the secondary impact plate 12 having a hydraulic actuator 42 having a fixed piston 44, and an extendible ram 46 attached to a part of the plate support frame 38. The piston 44 can be fixed to any suitable part of the remainder of the impact crusher assembly 2 or chassis of the impact crusher 1.

FIG. 3b shows the secondary impact plate 12 in a second position. FIG. 4b shows detail of the secondary impact plate 12 within portion A in FIGS. 1 and 3b, in the second position. FIG. 4b also shows the hydraulic actuator 42, fixed piston 44 and extendible ram 46, with the extendible ram 46 now extended from the piston 44 as described below.

From the first position shown in FIGS. 3a and 4a, to the second position shown in FIGS. 3b and 4b, the plate support frame 38 is translationally moved by the hydraulic actuator 42, by extension of its ram 46 so as to slide the side rails 50 on each side of the plate support frame 38 between the fixed side bars 36. In this way, the user of the impact crusher assembly 2 can adjust the gap between the secondary impact plate 12 and the blow bars 4, generally to either change the size of material the size of output material from the crushing zone, and/or to compensate for wear and tear of the front of the impact facing bars 40.

Other mechanisms able to provide translational movement of the secondary impact plate 12 relative to the rotor core 6 can involve other arrangements of support frames, assemblies and means.

FIGS. 4a and 4b also show a movement control mechanism in the form of threaded side control rods 51 having one, two or more nuts 52 thereon. One end of the control rod 51 is attached to a slide rail 50, and the other end can be fixed in a manner known in the art, such as to a fixed frame etc. of the chassis 70. The nuts 52 are moveable along the threaded rods 51 to be positioned to change the limit or degree of transitional movement possible, and so to define the extent of movement of the impact support plate 32.

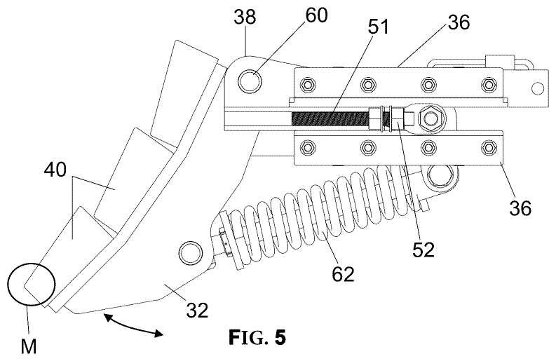

FIG. 5 shows a simple side view of the secondary impact plate 12 in the second position of FIGS. 3b and 4b. FIG. 5 shows the secondary support frame 12 also having a tramp metal relief mechanism in the form of a pivot point 60, and a compression spring 62 located between the impact support frame 32 and the plate support frame 38. This still allows pivotal movement of a lower end or portion of the impact support fame 32 relative to the blow bars 4, for the exceptional passage of uncrushable or tramp material in a manner known in the art. In this way, the plate support frame 38 of the present invention allows both translational and pivotal movement of the secondary impact plate 12 relative to rotor core 6 and/or chassis, to further improve the operation of the secondary impact plate 12.

In use, suitable feed material to be crushed is provided to the feeder 8 by any suitable provider, including conveyors and loaders (not shown), in a manner known in the art. The feeder 8 provides material to the crushing zone 26 for crushing the material between the blow bars 4 and primarily the primary impact plate 10, in a manner known in the art. Crushing is caused by the impact of the feed material against the primary impact plate 10, possibly one or more times, as the material is constantly in motion caused by rotation of the rotor core 6 and the blow bars 4, often involving ricocheting between the blow bars 4, the primary impact plate 10 and other material.

Once crushed material is small enough to fit between the blow bars 4 and the lowest crushing part or area of the crushing zone 26, such material can pass towards a suitable collection point, typically at or near the bottom of the crushing zone 26, and typically at or near the bottom of the impact crusher assembly 2. The crushing action may continue with the secondary impact plate 12 and its impact facing bars 40.

In the present invention, the method includes the step of being able to adjust the gap between all of the secondary impact plate 12 and the rotor core 6 and the ends of the blow bars 4. Adjusting the gap between the secondary impact plate 12 and the blow bars 4 allows the user to either change the size of material crushed by the impact crusher assembly, or to compensate for wear and tear of the closest part of the impact bars 40 (shown for example as circle M in FIG. 5), or both.

The present invention provides an assembly able to vary the gap between the whole secondary impact plate and the blow bars, to allow a user to quickly and easily change the size of material crushed by the impact crusher assembly, and thus change the size of output material. The present invention also allows the user to compensate for ‘wear and tear’ of the secondary impact plate relative to the rotor core over time.

As may be recognized by those of ordinary skill in the art based on the teachings herein, numerous changes and modifications may be made to the above-described and other embodiments of the present disclosure without departing from the scope of the disclosure. The components of the impact crusher assembly as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the impact crusher assembly may include more or fewer components or features than the embodiments as described and illustrated herein. Accordingly, this detailed description of the currently-preferred embodiments is to be taken in an illustrative, as opposed to limiting of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

1. An impact crusher assembly comprising a plurality of blow bars mounted on a rotor core able to rotate about an axis, a feeder for material to the blow bars, a primary impact plate co-operating with the blow bars and located radially outwardly from the blow bars, and a secondary impact plate located below the primary impact plate,
wherein the secondary impact plate is translationally moveable relative to rotor core.

2. An impact crusher assembly as claimed in claim 1, wherein the secondary impact plate comprises one or more impact facing bars mounted on a secondary support frame, and the secondary support frame is translationally moveable relative to the rotor core.

3. An impact crusher assembly as claimed in claim 1, wherein the secondary impact frame comprises a linear sliding mechanism able to change the gap between the secondary impact plate and the rotor core.

4. An impact crusher assembly as claimed in claim 3, wherein the linear sliding mechanism comprises a fixed part, and a relatively moveable part attached to the secondary impact plate.

5. An impact crusher assembly as claimed in claim 4, wherein the fixed part comprises side bars, and the relatively moveable part comprises slide rails.

6. An impact crusher assembly as claimed in claim 1, wherein the gap between the secondary impact plate and the rotor core is adjustable hydraulically or manually or both.

7. An impact crusher assembly as claimed in claim 1 further including an outlet conveyor below the rotor core, and wherein the secondary impact plate is located between the primary impact plate and the outlet conveyor.

8. An impact crusher assembly as claimed in claim 1, wherein the secondary support frame also includes a secondary impact plate hinge and relief mechanism.

9. An impact crusher assembly as claimed in claim 1 further comprising an adjustable movement control mechanism.

10. An impact crusher assembly as claimed in claim 1 further comprising a pre-screener between the feeder and the rotor core.

11. An impact crusher assembly as claimed as claimed in claim 10, wherein the pre-screener a fixed grid and a moveable grid.

12. An impact crusher assembly as claimed as claimed in claim 11, wherein the moveable grid is moveable in an eccentric motion relative to the fixed grid.

13. An impact crusher assembly as claimed in claim 1 mounted on a mobile chassis.

14. A method of impact crushing material in an impact crusher assembly comprising a plurality of blow bars mounted on a rotor core able to rotate about an axis, a feeder for material to the blow bars, a primary impact plate co-operating with the blow bars and located radially outwardly from the blow bars, and a secondary impact plate located below the primary impact plate, and wherein the secondary impact plate is translationally moveable relative to rotor core,
comprising the steps of:
(a) providing material to the feeder;
(b) crushing the material between the blow bars and the primary impact plate; and
(c) adjusting the gap between the secondary impact plate and rotor core by translationally moving the secondary impact plate.

15. A method as claimed in claim 14, wherein the secondary impact plate comprises one or more impact facing bars mounted on an impact support frame, and step (c) further comprises translationally moving the impact support frame relative to the rotor core.

16. A method as claimed in claim 15, wherein step (c) further comprises translationally moving the impact support frame along a linear sliding mechanism to change the gap between the secondary impact plate and the rotor core.

17. A method as claimed in claim 14, wherein step (c) further comprises hydraulically or manually or both translationally moving the secondary impact plate relative to the rotor core.

18. A method as claimed in claim 14 further comprising a secondary impact plate hinge and relief mechanism.
